(19) United States
(12) Patent Application Publication
(10) Pub. No.: US 2026/0167853 A1
(43) Pub. Date: Jun. 18, 2026

(54) UV ADHESION-REDUCING ADHESIVE FOR PO PROTECTIVE FILM FOR WAFER DICING AND PREPARATION METHOD THEREOF

(71) Applicant: Xi'an Aerospace Sunvalor Chemical Co., Ltd., Xi'an (CN)

(72) Inventors: Ying LIANG, Xi'an (CN); Pei WANG, Xi'an (CN); Jianghua ZHU, Xi'an (CN); Hanghang CHENG, Xi'an (CN); Ping LI, Xi'an (CN); Sheng CAO, Xi'an (CN); Hao ZHANG, Xi'an (CN)

(73) Assignee: Xi'an Aerospace Sunvalor Chemical Co., Ltd., Xi'an (CN)

(21) Appl. No.: 19/250,847

(22) Filed: Jun. 26, 2025

(30) Foreign Application Priority Data
Dec. 13, 2024 (CN) 202411834306.7

(51) Int. Cl. C09J 175/14; C08G 18/62; C08G 18/67

(52) U.S. Cl. CPC C09J 175/14; C08G 18/6254; C08G 18/673

(57) ABSTRACT

Provided are a UV adhesion-reducing adhesive for a polyolefin (PO) protective film for wafer dicing, and a preparation method thereof. The UV adhesion-reducing adhesive is prepared by raw materials including a component A and a component B, where the component A includes, in percentage by mass, 97-99.5% of an acrylate polymer, with a balance being a photoinitiator; the component B includes a curing agent; and the acrylate polymer is an acrylate polymer containing an unsaturated branched chain.

### CROSS REFERENCE TO RELATED APPLICATION

This patent application claims the benefit and priority of Chinese Patent Application No. 202411834306.7 filed with the China National Intellectual Property Administration on Dec. 13, 2024, and entitled with “UV ADHESION-REDUCING ADHESIVE FOR PO PROTECTIVE FILM FOR WAFER DICING AND PREPARATION METHOD THEREOF”, the disclosure of which is incorporated by reference herein in its entirety as part of the present application.

### TECHNICAL FIELD

The present disclosure relates to the technical field of pressure-sensitive adhesives, in particular to a UV adhesion-reducing adhesive for a polyolefin (PO) protective film for wafer dicing, and a preparation method thereof.

### BACKGROUND

Traditional blue films, also known as electronic-grade adhesive tapes, have certain supporting and protecting effects during a wafer dicing process. However, with the improvement of process automation, a good support force and a high pick-up rate are required after the completion of the process, thus putting forward higher use requirements on adhesives. During practical application, a traditional protective film consisting of a release film, a PO film, and an intermediate adhesive layer adheres to a wafer after the release film is removed, and the intermediate adhesive layer is bonded to the wafer. Under the condition that the intermediate adhesive layer has a relatively weak bonding force, high-speed rotation of a cutting knife will lead to the phenomena of cutting offset and edge warping.

A UV adhesion-reducing adhesive can be cured rapidly to form a strong bonding effect when cured with UV light, and further has a drastically reduced bonding force under UV irradiation, which makes it possible to solve the problem of the adhesion of traditional protective films being too high or too low to meet processing requirements. Currently, an adhesive layer made of an acrylate adhesive containing an unsaturated double bond in its side chain is commercially available as an adhesive for a protective film. The acrylate adhesive can play a protective role during dicing; however, the adhesive still has a relatively high bonding force after dicing is completed, leading to high removal difficulty, high wafer damage risk and difficulty in operation and implementation; moreover, the high-temperature resistance, the chemical resistance and the processability of the adhesive are required to be further improved.

Chinese patent CN119039890A discloses a UV adhesion-reducing adhesive solution, a UV adhesion-reducing film, and a display screen module, wherein the reinforcement and adhesion improvement of the UV adhesion-reducing film are achieved by means of the cooperation between a polyacrylic resin and a silane coupling agent containing a methoxy group. Chinese patent CN118652657A discloses a polyurethane-type UV adhesion-reducing adhesive based on a dimer acid and a preparation method thereof, wherein the 180° peel strength of the UV adhesion-reducing adhesive before UV irradiation and the adhesion-reducing effect after UV irradiation are improved by introducing a hydroxyl-terminal dimer acid-glycidyl methacrylate trimer prepolymer into the UV adhesion-reducing adhesive. However, none of these existing technologies solve all the technical problems described above since each of these existing technologies have the drawback of a relatively low peel strength before UV irradiation, or a yet high peel strength after UV irradiation, or poor stability and chemical resistance.

In view of the above, it is desirable to provide an adhesive for a PO protective film for wafer dicing that has properties such as good adhesion, high-temperature resistance, acid and alkali resistance, resistance to cutting fluids, no adhesive residue, and no adhesive overflow.

### SUMMARY

In view of the drawbacks and shortcomings of existing technologies, the present disclosure provides a photothermally-cured UV adhesion-reducing adhesive for a PO protective film for semiconductor wafer dicing. After the adhesive is coated onto a surface of a PO film substrate and cured to form an adhesive layer, the adhesive layer exhibits good acid and alkali resistance, high-temperature resistance, resistance to cutting fluids, and relatively high bonding force to a wafer, can replace traditional thermally-cured acrylate adhesive layers, and meets the market requirements for indexes.

A first aspect of the present disclosure provides a UV adhesion-reducing adhesive for a PO protective film for wafer dicing, prepared by raw materials including a component A and a component B, wherein:
the component A includes, in percentage by mass, 97-99.5% of an acrylate polymer, with a balance being a photoinitiator; and
the component B includes a curing agent.

In some embodiments, the acrylate polymer is an acrylate polymer containing an unsaturated branched chain.

In some embodiments, materials for preparing the acrylate polymer include: an acrylic monomer, a functional cross-linking monomer, an initiator, a diisocyanate, a catalyst, and an organic solvent. In some embodiments of the present disclosure, by subjecting the above materials to free radical polymerization combined with a graft modification reaction to obtain the acrylate polymer containing an unsaturated branched chain, with a solid content of 20-40%.

In some embodiments, the materials for preparing the acrylate polymer further include a co-solvent, and the co-solvent may include toluene.

In some embodiments, the acrylic monomer includes at least one selected from the group consisting of methyl acrylate, ethyl acrylate, 2-ethylhexyl acrylate, butyl acrylate, hydroxyethyl acrylate, hydroxypropyl methacrylate, methacrylic acid, methyl methacrylate, and butyl methacrylate.

In some embodiments, the acrylic monomer includes the 2-ethylhexyl acrylate, the butyl acrylate, the hydroxyethyl acrylate, the hydroxypropyl methacrylate, and the methacrylic acid; and a weight ratio of the 2-ethylhexyl acrylate, the butyl acrylate, the hydroxyethyl acrylate, the hydroxypropyl methacrylate, and the methacrylic acid is in a range of (10-15):(8-12):(1-4):(2-5):(1-3), and preferably 12.8:10.2:2.3:3:1.5.

In some embodiments, an additive amount of the acrylic monomer is 20-50% of a total mass of the acrylic monomer, the initiator, and the organic solvent, and preferably 25-40%.

Examples of the initiator may include azobisisobutyronitrile, benzoyl peroxide, lauroyl peroxide, cumene hydroperoxide, tert-butyl hydroperoxide, di-tert-butyl peroxide, dicumyl peroxide, tert-butyl peroxybenzoate, tert-butyl peroxypivalate, methyl ethyl ketone peroxide, cyclohexanone peroxide, or persulfate, and preferably azobisisobutyronitrile.

In some embodiments, an additive amount of the initiator is 0.05-0.3% of a total mass of the acrylic monomer, the initiator, and the organic solvent, and preferably 0.2%.

Examples of the organic solvent may include toluene, acetone, ethyl formate, ethyl acetate, ethanol, butanol, n-hexane, dichloromethane, diethyl ether, tetrahydrofuran, dimethylformamide, isooctyl ester, or ethylene glycol methyl ether, and preferably at least one selected from the group consisting of toluene, acetone and ethyl acetate.

In some embodiments, an additive amount of the organic solvent is 50-80% of a total mass of the acrylic monomer, the initiator, and the organic solvent, and preferably 60-75%.

In some embodiments, the functional cross-linking monomer is an acrylate monomer containing both an unsaturated double bond and a hydroxyl structure.

In some embodiments, the functional cross-linking monomer is one selected from the group consisting of pentaerythritol triacrylate and hydroxyethyl acrylate.

In some embodiments, an additive amount of the functional cross-linking monomer is 10-30% of a total mass of the functional cross-linking monomer, the diisocyanate, the catalyst, and the co-solvent, and preferably 15-25%.

Examples of the diisocyanate may include toluene diisocyanate (TDI), diphenylmethane diisocyanate (MDI), dicyclohexylmethane diisocyanate (H12MDI), hexamethylene diisocyanate (HDI), lysine diisocyanate (LDI), xylylene diisocyanate (XDI), or tetramethylxylylene diisocyanate (TMXDI), and preferably isophorone diisocyanate (IPDI).

In some embodiments, an additive amount of the diisocyanate is 40-60% of a total mass of the functional cross-linking monomer, the diisocyanate, the catalyst, and the co-solvent, and preferably 45-55%.

Examples of the catalyst may include dibutyltin dilaurate, stannous octoate, triethylenediamine and derivatives thereof, or dimethylcyclohexylamine, and preferably dibutyltin dilaurate.

In some embodiments, an additive amount of the catalyst is 0.01-1% of a total mass of the functional cross-linking monomer, the diisocyanate, the catalyst, and the co-solvent.

In some embodiments, the acrylate polymer is prepared by a process including the following steps:
(1) mixing the acrylic monomer with the initiator and the organic solvent, and subjecting a resulting mixture to a first reaction to obtain an acrylate oligomer;
(2) mixing the functional cross-linking monomer with the diisocyanate and the catalyst to obtain a polyurethane acrylate prepolymer containing an unsaturated double bond and an isocyanate group; and
(3) mixing products obtained in steps (1) and (2), and subjecting a resulting mixed system to a second reaction to generate an acrylate polymer containing an unsaturated branched chain.

In some embodiments, under a condition that the functional cross-linking monomer is the pentaerythritol triacrylate, in step (3), the products obtained in steps (1) and (2) are mixed at a molar ratio of —OH to —NCO of 1:(0.15-0.25), and preferably 1:2.

In some embodiments, under a condition that the functional cross-linking monomer is the hydroxyethyl acrylate, in step (3), the products obtained in steps (1) and (2) are mixed at a molar ratio of —OH to —NCO of 1:(0.65-0.95), and preferably 1:8.

In some embodiments, the co-solvent is added in step (2).

The UV adhesion-reducing adhesive has the characteristic of a high bonding force during dicing in a thermal curing stage, and can replace traditional protective adhesive films. This is because after the application of the UV adhesion-reducing adhesive is completed, double bonds undergo a free radical polymerization reaction rapidly under the action of a light source, and at this moment, a transverse shrinkage effect is produced during the polymerization of the double bonds, leading to a rapid reduction in the bonding force between the UV adhesion-reducing adhesive and a wafer. Further, after the polymerization of double bonds on side chains, the molecular weight of the UV adhesion-reducing adhesive suddenly increases, the cross-linking density is significantly increased, so that the two-dimensional cross-linking structure turns into a three-dimensional cross-linking structure, and the hardness and cohesion of an adhesive layer are greatly improved, thereby reducing the action force between the UV adhesion-reducing adhesive and the wafer. Under the synergistic effect of double-bond shrinkage and increased hardness, the PO protective film prepared from the UV adhesion-reducing adhesive can be quickly detached from the wafer.

In the present disclosure, the functional cross-linking monomer is selected to be pentaerythritol triacrylate or hydroxyethyl acrylate, which react with isophorone diisocyanate to prepare a polyurethane acrylate prepolymer containing a unsaturated double bond and am isocyanate group, denoted as oligomer A or oligomer B. Through experimental investigation, under the condition that the molar ratio of —OH to —NCO during a reaction is different, i.e., the grafting amount of oligomer A or oligomer B in the acrylate polymer is different, the peel strengths of the ultimate UV adhesion-reducing adhesive before and after UV curing are significantly different, and the high-temperature stability of the UV adhesion-reducing adhesive also has the difference between good and bad. Only when a proper molar ratio is maintained, the peel strength of the ultimately obtained UV adhesion-reducing adhesive can be reduced to almost 0 after UV curing, it is easy to peel off, and there is no residual adhesive after the high-temperature treatment.

The oligomer A has a structural formula shown as follows:

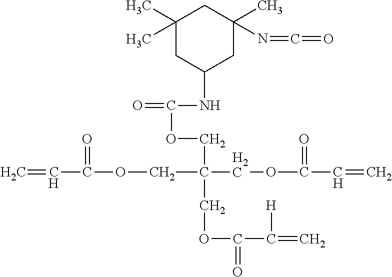 [SMILES: C=CC(=O)OCC(COC(=O)C=C)(COC(=O)C=C)COC(=O)NC1CC(C)(C)CC(C)(N=C=O)C1]

The oligomer B has a structural formula shown as follows:

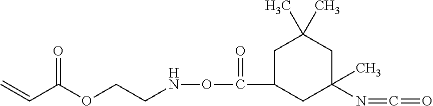 [SMILES: C=CC(=O)OCCNOC(=O)C1CC(C)(C)CC(C)(N=C=O)C1]

In some embodiments, the photoinitiator includes a free radical polymerization photoinitiator, examples of which may include 1-hydroxycyclohexyl phenyl ketone (photoinitiator 184), 2,4,6-trimethylbenzoyldiphenyl phosphine oxide (TPO), 2-hydroxy-2-methyl-1-phenylpropanone (photoinitiator 1173), benzoin dimethyl ether (BDK), 2-methyl-1-[4-methylthiophenyl]-2-morpholino-1-propanone (photoinitiator 907), 2-phenylbenzyl-2-dimethylamino-1-(4-morpholinobenzylphenyl)butanone (photoinitiator 369), phenylbis(2,4,6-trimethylbenzoyl)phosphine oxide (photoinitiator 819), or 2-hydroxy-1-(4-(2-hydroxy-2-methylpropionylphenyl)benzyl)-2-methyl-1-propanone (photoinitiator 127).

In some embodiments, the photoinitiator includes 1-hydroxycyclohexyl phenyl ketone and 2,4,6-trimethylbenzoyldiphenyl phosphine oxide; and a weight ratio of the 1-hydroxycyclohexyl phenyl ketone to the 2,4,6-trimethylbenzoyldiphenyl phosphine oxide is in a range of 1:(1.1-1.5).

In some embodiments, an additive amount of the curing agent is 0.5-3% of a mass of the component A, and preferably 1.5%.

In some embodiments, the curing agent includes an isocyanate-based oligomer.

In some embodiments, the isocyanate-based oligomer includes a compound of a hydrophilic aliphatic polyisocyanate and an aromatic polyisocyanate.

Examples of the hydrophilic aliphatic polyisocyanate may include Covestro 3100.

Examples of the aromatic polyisocyanate may include Bayer L-75.

In some embodiments, a mass ratio of the hydrophilic aliphatic polyisocyanate to the aromatic polyisocyanate is in a range of 1:(2-5).

In some embodiments, in step (1), the first reaction is conducted at a temperature of 75° C. to 85° C., and the first reaction is conducted for 7 h to 10 h.

In some embodiments, in step (3), the second reaction is conducted at a temperature of 35° C. to 45° C., and the second reaction is conducted for 5 h to 7 h.

A second aspect of the present disclosure provides a method for preparing the UV adhesion-reducing adhesive for the PO protective film for wafer dicing, including: sequentially adding the acrylate polymer and the photoinitiator to a reaction kettle, and stirring until the photoinitiator is completely dissolved; discharging a resulting material to obtain the component A; and in use, mixing the component A and the component B according to formula amounts to obtain the UV adhesion-reducing adhesive product.

In some embodiments, all preparation processes of the UV adhesion-reducing adhesive are conducted under yellow light conditions.

### Beneficial Effects

The present disclosure provides a UV adhesion-reducing adhesive for a PO protective film for wafer dicing and a preparation method thereof, which have the following advantages:

(1) In the present disclosure, an acrylate polymer containing an unsaturated branched chain is synthesized and reacts with a photoinitiator and a curing agent to generate a UV adhesion-reducing adhesive with flexible and adjustable peel strength, and good processability. The resulting UV adhesion-reducing adhesive can reduce the offset rate of wafer dicing and avoid the corrosion and adhesive residue contamination caused by acidic and alkali liquids, cutting fluids, and high temperatures for wafers during dicing, thereby improving the yield of the wafers.

(2) In the present disclosure, pentaerythritol triacrylate or hydroxyethyl acrylate is specifically selected as a functional cross-linking monomer, and cooperates with a diisocyanate for a reaction with an acrylate prepolymer to graft an unsaturated bond and an isocyanate group into the structure of the acrylate polymer. The resulting adhesive material can maintain a relatively high peel strength before UV treatment, but the peel strength quickly drops to nearly 0 after UV treatment. Thus, the adhesive material can achieve a firm bond, and be thoroughly separated from a substrate when peeling is required. This meets the usage requirements of a PO protective film for wafer dicing very well.

(3) In the present disclosure, the grafting amount of the functional cross-linking monomer during the reaction is controlled to take into account the initial peel strength of the adhesive, the degree of reduction in the peel strength of the adhesive after UV curing and high-temperature stability to the greatest extent possible. The resulting UV adhesion-reducing adhesive has a peel strength of up to 1000 g/25 cm or more before UV curing, and a peel strength as low as 0.1 g/25 cm or less after UV curing. Moreover, there is no residual adhesive when the UV adhesion-reducing adhesive is removed after being treated at 180° C. for 2 h, and the UV adhesion-reducing adhesive has good overall performance.

(4) In the present disclosure, by means of a specific formula for the UV adhesion-reducing adhesive, especially the design of reaction raw material including an acrylate prepolymer and a polyurethane acrylate prepolymer, good compatibility between polymerization systems is achieved, and a suitable degree of freedom of the reaction is maintained, thereby generating a UV adhesion-reducing adhesive with glue soft hardness and suitable viscosity loss performance, which effectively solves the technical problems that acrylate adhesives, after the completion of dicing, still have a high bonding force, are difficult to remove and are likely to cause damage to wafers.

(5) The UV adhesion-reducing adhesive of the present disclosure can be used to prepare a PO protective film for wafer dicing by methods, such as spin coating, for further use in coating production and subsequent wafer dicing. Moreover, the raw materials of the present disclosure are easily available, and the preparation process is simple. Furthermore, the present disclosure can meet the requirements of mass production, and high-quality electronic products can be produced. The present disclosure is of positive significance in the field of industrial production of semiconductors and has broad application prospects.

### DETAILED DESCRIPTION OF THE EMBODIMENTS

Note: Unless otherwise specified, all the raw materials involved in the present disclosure are commercially available.

### EXAMPLE

### Example 1

A first aspect of this example provided a UV adhesion-reducing adhesive for a PO protective film for wafer dicing, prepared by raw materials consisted of a component A and a component B.

The component A consisted of, in percentage by mass, 98.5% of an acrylate polymer and 1.5% of a photoinitiator, and the acrylate polymer was an acrylate polymer containing an unsaturated branched chain.

Materials for preparing the acrylate polymer consisted of: an acrylic monomer, a functional cross-linking monomer, an initiator, a diisocyanate, a catalyst, an organic solvent, and a co-solvent.

Based on a total mass of the acrylic monomer, the initiator and the organic solvent, the acrylic monomer included 12.8% of 2-ethylhexyl acrylate, 10.2% of butyl acrylate, 2.3% of hydroxyethyl acrylate, 3% of hydroxypropyl methacrylate, and 1.5% of methacrylic acid; the initiator was 0.2% of azobisisobutyronitrile; and the organic solvents included 45.65% of ethyl acetate, 9.35% of toluene, and 15% of acetone.

Based on a total mass of the functional cross-linking monomer, the diisocyanate, the catalyst and the co-solvent, the functional cross-linking monomer was 20.7% of pentaerythritol triacrylate, the diisocyanate was 49.23% of isophorone diisocyanate, the catalyst was 0.07% of dibutyltin dilaurate, and the co-solvent was 30% of toluene.

The acrylate polymer was prepared by a process consisting of the following steps:
(1) the acrylic monomer was mixed with the initiator and the organic solvent, and a resulting mixture was subjected to a first reaction to obtain an acrylate prepolymer;
(2) the functional cross-linking monomer was mixed with the diisocyanate, the catalyst and the co-solvent to obtain a polyurethane acrylate prepolymer (oligomer A) containing an unsaturated double bond and an isocyanate group; and
(3) products obtained in steps (1) and (2) were mixed at a molar ratio of —OH to —NCO being 1:0.8, and a resulting mixed system was subjected to a second reaction to generate an acrylate polymer containing an unsaturated branched chain, with a solid content of 30 wt %.

In step (1), the first reaction was conducted at 80° C. for 9 h; and in step (3), the second reaction was conducted at 45° C. for 6 h.

The photoinitiator was composed of 1-hydroxycyclohexyl phenyl ketone and 2,4,6-trimethylbenzoyldiphenyl phosphine oxide with a weight ratio of 45:55.

The component B was a curing agent, and an additive amount of the curing agent was 1% of a mass of the component A.

The curing agent was a compound of a hydrophilic aliphatic polyisocyanate (Covestro 3100) and an aromatic polyisocyanate (Bayer L-75).

A mass ratio of Covestro 3100 to Bayer L-75 was 1:3.

A second aspect of this example provided a method for preparing the above UV adhesion-reducing adhesive, which was performed as follows: the acrylate polymer and the photoinitiator were sequentially added to a reaction kettle, and stirred until the photoinitiator was completely dissolved; a resulting material was discharged to obtain the component A; and in use, the component A and the component B were mixed according to formula amounts to obtain the UV adhesion-reducing adhesive, wherein all the preparation processes were conducted under yellow light conditions.

### Example 2

A first aspect of this example provided a UV adhesion-reducing adhesive for a PO protective film for wafer dicing, prepared by raw materials consisted of a component A and a component B.

The component A consisted of, in percentage by mass, 98.5% of an acrylate polymer and 1.5% of a photoinitiator, and the acrylate polymer was an acrylate polymer containing an unsaturated branched chain.

Materials for preparing the acrylate polymer consisted of: an acrylic monomer, a functional cross-linking monomer, an initiator, a diisocyanate, a catalyst, an organic solvent, and a co-solvent.

Based on a total mass of the acrylic monomer, the initiator and the organic solvent, the acrylic monomer included 12.8% of 2-ethylhexyl acrylate, 10.2% of butyl acrylate, 2.3% of hydroxyethyl acrylate, 3% of hydroxypropyl methacrylate, and 1.5% of methacrylic acid; the initiator was 0.2% of azobisisobutyronitrile; and the organic solvents included 45.65% of ethyl acetate, 9.35% of toluene, and 15% of acetone.

Based on a total mass of the functional cross-linking monomer, the diisocyanate, the catalyst and the co-solvent, the functional cross-linking monomer was 24% of hydroxyethyl acrylate, the diisocyanate was 45.22% of isophorone diisocyanate, the catalyst was 0.8% of dibutyltin dilaurate, and the co-solvent was 29.98% of toluene.

The acrylate polymer was prepared by a process consisting of the following steps:
(1) the acrylic monomer was mixed with the initiator and the organic solvent, and a resulting mixture was subjected to a first reaction to obtain an acrylate prepolymer;
(2) the functional cross-linking monomer was mixed with the diisocyanate, the catalyst and the co-solvant to obtain a polyurethane acrylate prepolymer (oligomer B) containing an unsaturated double bond and an isocyanate group; and
(3) products obtained in steps (1) and (2) were mixed at a molar ratio of —OH to —NCO being 1:0.1, and a resulting mixed system was subjected to a second reaction to generate an acrylate polymer containing an unsaturated branched chain, with a solid content of 30 wt %.

In step (1), the first reaction was conducted at 80° C. for 9 h; and in step (3), the second reaction was conducted at 45° C. for 6 h.

The photoinitiator was composed of 1-hydroxycyclohexyl phenyl ketone and 2,4,6-trimethylbenzoyldiphenyl phosphine oxide with a weight ratio of 45:55.

The component B was a curing agent, and an additive amount of the curing agent was 1% of a mass of the component A.

The curing agent was a compound of a hydrophilic aliphatic polyisocyanate (Covestro 3100) and an aromatic polyisocyanate (Bayer L-75).

A mass ratio of Covestro 3100 to Bayer L-75 was 1:3.

A second aspect of this example provided a method for preparing the above UV adhesion-reducing adhesive, which was performed as follows: the acrylate polymer and the photoinitiator were sequentially added to a reaction kettle, and stirred until the photoinitiator was completely dissolved; a resulting material was discharged to obtain the component A; and in use, the component A and the component B were mixed according to formula amounts to obtain the UV adhesion-reducing adhesive, wherein all the preparation processes were conducted under yellow light conditions.

### Comparative Example 1

A first aspect of this comparative example provided a UV adhesion-reducing adhesive for a PO protective film for wafer dicing, prepared by raw materials consisted of a component A and a component B.

The component A consisted of, in percentage by mass, 98.5% of an acrylate polymer and 1.5% of a photoinitiator, and the acrylate polymer was an acrylate polymer containing an unsaturated branched chain.

Materials for preparing the acrylate polymer consisted of: an acrylic monomer, a functional cross-linking monomer, an initiator, a diisocyanate, a catalyst, an organic solvent, and a co-solvent.

Based on a total mass of the acrylic monomer, the initiator and the organic solvent, the acrylic monomer included 12.8% of 2-ethylhexyl acrylate, 10.2% of butyl acrylate, 2.3% of hydroxyethyl acrylate, 3% of hydroxypropyl methacrylate, and 1.5% of methacrylic acid; the initiator was 0.2% of azobisisobutyronitrile; and the organic solvents included 45.65% of ethyl acetate, 9.35% of toluene, and 15% of acetone.

Based on a total mass of the functional cross-linking monomer, the diisocyanate, the catalyst and the co-solvent, the functional cross-linking monomer was 20.7% of pentaerythritol triacrylate, the diisocyanate was 49.23% of isophorone diisocyanate, the catalyst was 0.07% of dibutyltin dilaurate, and the co-solvent was 30% of toluene.

The acrylate polymer was prepared by a process consisting of the following steps:
(1) the acrylic monomer was mixed with the initiator and the organic solvent, and a resulting mixture was subjected to a first reaction to obtain an acrylate prepolymer;
(2) the functional cross-linking monomer was mixed with the diisocyanate, the catalyst and the co-solvant to obtain a polyurethane acrylate prepolymer (oligomer A) containing an unsaturated double bond and an isocyanate group; and
(3) products obtained in steps (1) and (2) were mixed at a molar ratio of —OH to —NCO being 1:0.1, and a resulting mixed system was subjected to a second reaction to generate an acrylate polymer containing an unsaturated branched chain, with a solid content of 30 wt %.

In step (1), the first reaction was conducted at 80° C. for 9 h; and in step (3), the second reaction was conducted at 45° C. for 6 h.

The photoinitiator was composed of 1-hydroxycyclohexyl phenyl ketone and 2,4,6-trimethylbenzoyldiphenyl phosphine oxide with a weight ratio of 45:55.

The component B was a curing agent, and an additive amount of the curing agent was 1% of a mass of the component A.

The curing agent was a compound of a hydrophilic aliphatic polyisocyanate (Covestro 3100) and an aromatic polyisocyanate (Bayer L-75).

A mass ratio of Covestro 3100 to Bayer L-75 was 1:3.

A second aspect of this comparative example provided a method for preparing the above UV adhesion-reducing adhesive, which was performed as follows: the acrylate polymer and the photoinitiator were sequentially added to a reaction kettle, and stirred until the photoinitiator was completely dissolved; a resulting material was discharged to obtain the component A; and in use, the component A and the component B were mixed according to formula amounts to obtain the UV adhesion-reducing adhesive, wherein all the preparation processes were conducted under yellow light conditions.

### Comparative Example 2

A first aspect of this comparative example provided a UV adhesion-reducing adhesive for a PO protective film for wafer dicing, prepared by raw materials consisted of a component A and a component B.

The component A consisted of, in percentage by mass, 98.5% of an acrylate polymer and 1.5% of a photoinitiator, and the acrylate polymer was an acrylate polymer containing an unsaturated branched chain.

Materials for preparing the acrylate polymer consisted of: an acrylic monomer, a functional cross-linking monomer, an initiator, a diisocyanate, a catalyst, an organic solvent, and a co-solvent.

Based on a total mass of the acrylic monomer, the initiator and the organic solvent, the acrylic monomer included 12.8% of 2-ethylhexyl acrylate, 10.2% of butyl acrylate, 2.3% of hydroxyethyl acrylate, 3% of hydroxypropyl methacrylate, and 1.5% of methacrylic acid; the initiator was 0.2% of azobisisobutyronitrile; and the organic solvents included 45.65% of ethyl acetate, 9.35% of toluene, and 15% of acetone.

Based on a total mass of the functional cross-linking monomer, the diisocyanate, the catalyst and the co-solvent, the functional cross-linking monomer was 20.7% of pentaerythritol triacrylate, the diisocyanate was 49.23% of isophorone diisocyanate, the catalyst was 0.07% of dibutyltin dilaurate, and the co-solvent was 30% of toluene.

The acrylate polymer was prepared by a process consisting of the following steps:
(1) the acrylic monomer was mixed with the initiator and the organic solvent, and a resulting mixture was subjected to a first reaction to obtain an acrylate prepolymer;
(2) the functional cross-linking monomer was mixed with the diisocyanate, the catalyst and the co-solvant to obtain a polyurethane acrylate prepolymer (oligomer A) containing an unsaturated double bond and an isocyanate group; and
(3) products obtained in steps (1) and (2) were mixed at a molar ratio of —OH to —NCO being 1:0.3, and a resulting mixed system was subjected to a second reaction to generate an acrylate polymer containing an unsaturated branched chain, with a solid content of 30 wt %.

In step (1), the first reaction was conducted at 80° C. for 9 h; and in step (3), the second reaction was conducted at 45° C. for 6 h.

The photoinitiator was composed of 1-hydroxycyclohexyl phenyl ketone and 2,4,6-trimethylbenzoyldiphenyl phosphine oxide with a weight ratio of 45:55.

The component B was a curing agent, and an additive amount of the curing agent was 1% of a mass of the component A.

The curing agent was a compound of a hydrophilic aliphatic polyisocyanate (Covestro 3100) and an aromatic polyisocyanate (Bayer L-75).

A mass ratio of Covestro 3100 to Bayer L-75 was 1:3.

A second aspect of this comparative example provided a method for preparing the above UV adhesion-reducing adhesive, which was performed as follows: the acrylate polymer and the photoinitiator were sequentially added to a reaction kettle, and stirred until the photoinitiator was completely dissolved; a resulting material was discharged to obtain the component A; and in use, the component A and the component B were mixed according to formula amounts to obtain the UV adhesion-reducing adhesive, wherein all the preparation processes were conducted under yellow light conditions.

### Comparative Example 3

A first aspect of this comparative example provided a UV adhesion-reducing adhesive for a PO protective film for wafer dicing, prepared by raw materials consisted of a component A and a component B.

The component A consisted of, in percentage by mass, 98.5% of an acrylate polymer and 1.5% of a photoinitiator, and the acrylate polymer was an acrylate polymer containing an unsaturated branched chain.

Materials for preparing the acrylate polymer consisted of: an acrylic monomer, a functional cross-linking monomer, an initiator, a diisocyanate, a catalyst, an organic solvent, and a co-solvent.

Based on a total mass of the acrylic monomer, the initiator and the organic solvent, the acrylic monomer included 12.8% of 2-ethylhexyl acrylate, 10.2% of butyl acrylate, 2.3% of hydroxyethyl acrylate, 3% of hydroxypropyl methacrylate, and 1.5% of methacrylic acid; the initiator was 0.2% of azobisisobutyronitrile; and the organic solvents included 45.65% of ethyl acetate, 9.35% of toluene, and 15% of acetone.

Based on a total mass of the functional cross-linking monomer, the diisocyanate, the catalyst and the co-solvent, the functional cross-linking monomer was 24% of hydroxyethyl acrylate, the diisocyanate was 45.22% of isophorone diisocyanate, the catalyst was 0.8% of dibutyltin dilaurate, and the co-solvent was 29.98% of toluene.

The acrylate polymer was prepared by a process consisting of the following steps:
(1) the acrylic monomer was mixed with the initiator and the organic solvent, and a resulting mixture was subjected to a first reaction to obtain an acrylate prepolymer;
(2) the functional cross-linking monomer was mixed with the diisocyanate, the catalyst and the co-solvant to obtain a polyurethane acrylate prepolymer (oligomer B) containing an unsaturated double bond and an isocyanate group; and
(3) products obtained in steps (1) and (2) were mixed at a molar ratio of —OH to —NCO being 1:1, and a resulting mixed system was subjected to a second reaction to generate an acrylate polymer containing an unsaturated branched chain, with a solid content of 30 wt %.

In step (1), the first reaction was conducted at 80° C. for 9 h; and in step (3), the second reaction was conducted at 45° C. for 6 h.

The photoinitiator was composed of 1-hydroxycyclohexyl phenyl ketone and 2,4,6-trimethylbenzoyldiphenyl phosphine oxide with a weight ratio of 45:55.

The component B was a curing agent, and an additive amount of the curing agent was 1% of a mass of the component A.

The curing agent was a compound of a hydrophilic aliphatic polyisocyanate (Covestro 3100) and an aromatic polyisocyanate (Bayer L-75).

A mass ratio of Covestro 3100 to Bayer L-75 was 1:3.

A second aspect of this comparative example provided a method for preparing the above UV adhesion-reducing adhesive, which was performed as follows: the acrylate polymer and the photoinitiator were sequentially added to a reaction kettle, and stirred until the photoinitiator was completely dissolved; a resulting material was discharged to obtain the component A; and in use, the component A and the component B were mixed according to formula amounts to obtain the UV adhesion-reducing adhesive, wherein all the preparation processes were conducted under yellow light conditions.

### Comparative Example 4

A first aspect of this comparative example provided a UV adhesion-reducing adhesive for a PO protective film for wafer dicing, prepared by raw materials consisted of a component A and a component B.

The component A consisted of, in percentage by mass, 98.5% of an acrylate polymer and 1.5% of a photoinitiator, and the acrylate polymer was an acrylate polymer containing an unsaturated branched chain.

Materials for preparing the acrylate polymer consisted of: an acrylic monomer, a functional cross-linking monomer, an initiator, a diisocyanate, a catalyst, an organic solvent, and a co-solvent.

Based on a total mass of the acrylic monomer, the initiator and the organic solvent, the acrylic monomer included 12.8% of 2-ethylhexyl acrylate, 10.2% of butyl acrylate, 2.3% of hydroxyethyl acrylate, 3% of hydroxypropyl methacrylate, and 1.5% of methacrylic acid; the initiator was 0.2% of azobisisobutyronitrile; and the organic solvents included 45.65% of ethyl acetate, 9.35% of toluene, and 15% of acetone.

Based on a total mass of the functional cross-linking monomer, the diisocyanate, the catalyst and the co-solvent, the functional cross-linking monomer was 24% of hydroxyethyl acrylate, the diisocyanate was 45.22% of isophorone diisocyanate, the catalyst was 0.8% of dibutyltin dilaurate, and the co-solvent was 29.98% of toluene.

The acrylate polymer was prepared by a process consisting of the following steps:
(1) the acrylic monomer was mixed with the initiator and the organic solvent, and a resulting mixture was subjected to a first reaction to obtain an acrylate prepolymer;
(2) the functional cross-linking monomer was mixed with the diisocyanate, the catalyst and the co-solvant to obtain a polyurethane acrylate prepolymer (oligomer B) containing an unsaturated double bond and an isocyanate group; and
(3) products obtained in steps (1) and (2) were mixed at a molar ratio of —OH to —NCO of 1:0.6, and a resulting mixed system was subjected to a second reaction to generate an acrylate polymer containing an unsaturated branched chain, with a solid content of 30 wt %.

In step (1), the first reaction was conducted at 80° C. for 9 h; and in step (3), the second reaction was conducted at 45° C. for 6 h.

The photoinitiator was composed of 1-hydroxycyclohexyl phenyl ketone and 2,4,6-trimethylbenzoyldiphenyl phosphine oxide with a weight ratio of 45:55.

The component B was a curing agent, and an additive amount of the curing agent was 1% of a mass of the component A.

The curing agent was a compound of a hydrophilic aliphatic polyisocyanate (Covestro 3100) and an aromatic polyisocyanate (Bayer L-75).

A mass ratio of Covestro 3100 to Bayer L-75 was 1:3.

A second aspect of this comparative example provided a method for preparing the above UV adhesion-reducing adhesive, which was performed as follows: the acrylate polymer and the photoinitiator were sequentially added to a reaction kettle, and stirred until the photoinitiator was completely dissolved; a resulting material was discharged to obtain the component A; and in use, the component A and the component B were mixed according to formula amounts to obtain the UV adhesion-reducing adhesive, wherein all the preparation processes were conducted under yellow light conditions.

### Comparative Example 5

A first aspect of this comparative example provided a UV adhesion-reducing adhesive for a PO protective film for wafer dicing, prepared by raw materials consisted of a component A and a component B.

The component A consisted of, in percentage by mass, 98.5% of an acrylate polymer and 1.5% of a photoinitiator, and the acrylate polymer was an acrylate polymer containing an unsaturated branched chain.

Materials for preparing the acrylate polymer consisted of: an acrylic monomer, a functional cross-linking monomer, an initiator, a diisocyanate, a catalyst, an organic solvent, and a co-solvent.

Based on a total mass of the acrylic monomer, the initiator and the organic solvent, the acrylic monomer included 12.8% of 2-ethylhexyl acrylate, 10.2% of butyl acrylate, 2.3% of hydroxyethyl acrylate, 3% of hydroxypropyl methacrylate, and 1.5% of methacrylic acid; the initiator was 0.2% of azobisisobutyronitrile; and the organic solvents included 45.65% of ethyl acetate, 9.35% of toluene, and 15% of acetone.

Based on a total mass of the functional cross-linking monomer, the diisocyanate, the catalyst and the co-solvent, the functional cross-linking monomer was 24% of hydroxyethyl acrylate, the diisocyanate was 45.22% of isophorone diisocyanate, the catalyst was 0.8% of dibutyltin dilaurate, and the co-solvent was 29.98% of toluene.

The acrylate polymer was prepared by a process consisting of the following steps:
(1) the acrylic monomer was mixed with the initiator and the organic solvent, and a resulting mixture was subjected to a first reaction to obtain an acrylate prepolymer;
(2) the functional cross-linking monomer was mixed with the diisocyanate, the catalyst and the co-solvant to obtain a polyurethane acrylate prepolymer (oligomer B) containing an unsaturated double bond and an isocyanate group; and
(3) products obtained in steps (1) and (2) were mixed at a molar ratio of —OH to —NCO being 1:0.2, and a resulting mixed system was subjected to a second reaction to generate an acrylate polymer containing an unsaturated branched chain, with a solid content of 30 wt %.

In step (1), the first reaction was conducted at 80° C. for 9 h; and in step (3), the second reaction was conducted at 45° C. for 6 h.

The photoinitiator was composed of 1-hydroxycyclohexyl phenyl ketone and 2,4,6-trimethylbenzoyldiphenyl phosphine oxide with a weight ratio of 45:55.

The component B was a curing agent, and an additive amount of the curing agent was 1% of a mass of the component A.

The curing agent was a compound of a hydrophilic aliphatic polyisocyanate (Covestro 3100) and an aromatic polyisocyanate (Bayer L-75).

A mass ratio of Covestro 3100 to Bayer L-75 was 1:3.

A second aspect of this comparative example provided a method for preparing the above UV adhesion-reducing adhesive, which was performed as follows: the acrylate polymer and the photoinitiator were sequentially added to a reaction kettle, and stirred until the photoinitiator was completely dissolved; a resulting material was discharged to obtain the component A; and in use, the component A and the component B was mixed according to formula amounts to obtain the UV adhesion-reducing adhesive, wherein all the preparation processes were conducted under yellow light conditions.

### Performance Test

Preparation method for adhesive film: the UV adhesion-reducing adhesives prepared in Examples 1-2 and Comparative Examples 1-5 were coated onto surfaces of 150 μm PO films by means of knife coating. Resulting films were dried at 120° C. for 2 min to remove solvents, covered with release films, and then placed in an oven at 65° C. for 48 h to prepare UV adhesion-reducing films. The UV adhesion-reducing films each were subjected to a UV treatment (light energy: 300 mJ) to test the performance of the adhesives before and after the UV treatment. The test results are shown in Table 1 below.

The peel strength therein was tested with reference to the 180° peel strength test method in Chinese Standard GB/T 2792-2014.

Acid resistance: the prepared UV adhesive films were placed in an aqueous hydrofluoric acid solution with a concentration of 40 wt % for treatment for 30 min, and then taken out to observe whether there was any penetration.

Alkali resistance: the prepared UV adhesive films were placed in an aqueous sodium hydroxide solution with a concentration of 50 wt % for treatment for 60 min, and then taken out to observe whether there was any penetration.

Resistance to cutting fluids: the prepared UV adhesive films were placed in a cutting fluid (specifically the product Huayi Bluesky HX-8000, whose main component was polyethylene glycol) for treatment for 30 min, and then taken out to observe whether there was any penetration.

TABLE 1
Performance test results of UV adhesion-reducing adhesive

| | Example | Example | Comparative | Comparative | Comparative | Comparative | Comparative |
|---|---|---|---|---|---|---|---|
| | 1 | 2 | example 1 | example 2 | example 3 | example 4 | example 5 |
| OH:NCO | 1:0.2 | 1:0.8 | 1:0.1 | 1:0.3 | 1:1 | 1:0.6 | 1:0.4 |
| (molar ratio) | | | | | | | |
| Peel strength | 1200 | 1218 | 1427 | 1079 | 1465 | 1236 | 1189 |
| before UV | | | | | | | |
| treatment | | | | | | | |
| (g/25 mm) | | | | | | | |
| Peel strength | 0.1 | 0.2 | 2 | 0 | 0.1 | 2.5 | 6 |
| after UV | | | | | | | |
| treatment | | | | | | | |
| (g/25 mm) | | | | | | | |
| Sustained | 0 | 0 | 0 | 0.1 | 1 | 0 | 0.5 |
| adhesion | | | | | | | |
| (1 kg, 24 h, | | | | | | | |
| displacement: | | | | | | | |
| mm) | | | | | | | |
| High- | No | No | No | Adhesive | Adhesive | No | Adhesive |
| temperature | adhesive | adhesive | adhesive | residue | residue | adhesive | residue 3% |
| resistance | residue | residue | residue | content 2% | content 4% | residue | |
| (180° C., 2 h) | | | | | | | |
| Acid and | No | No | No | No | No | No | No |
| alkali | penetration | penetration | penetration | penetration | penetration | penetration | penetration |
| resistance | | | | | | | |
| Resistance to | No | No | No | No | No | No | No |
| cutting fluid | penetration | penetration | penetration | penetration | penetration | penetration | penetration |

As can be seen from Table 1, the UV adhesion-reducing adhesives obtained in Examples 1 and 2 have relatively high peel strengths before UV curing and significantly reduced peel strengths after UV curing, and can maintain better sustained adhesion, high-temperature resistance, and chemical resistance, whereas the UV adhesion-reducing adhesives prepared in Comparative Examples 1-5 show different degrees of deterioration. Specifically, the peel strength of the adhesive of Comparative Example 1 is still high after UV curing, which is not conducive to peeling. Presumably, when the grafting amount of PDI is small, the content of double bonds is low, and the peel force of the adhesive material is difficult to drop to a level near 0 after illumination. Both Comparative Examples 2 and 3 show that there are still some residual adhesives after high-temperature treatment. Presumably, when the addition amounts of oligomer A and oligomer B are excessive, the presence of small-molecular cross-linking monomers destroys the cohesion of acrylate polymers, and the stability of the adhesive materials is poor, resulting in the appearance of residual adhesives after high-temperature treatment. The adhesive of Comparative Example 4 still has a high peel strength after UV curing. Presumably, when the grafting amount of oligomer B is small, the double bond content is low, and the shrinkage force of double bonds is insufficient. Therefore, the degree of reduction in the peel strength of the UV adhesion-reducing adhesive is small. The adhesive of Comparative Example 5 still has a high peel strength after UV curing, and there is still residual adhesive after high-temperature treatment. Presumably, when the grafting amount G of oligomer B is too small, the double bond content is low, and meanwhile, the cross-linking density of the adhesive material is relatively low, which makes it difficult for the peel force of the adhesive material to decrease after illumination and leaves residual adhesive after high-temperature treatment.

What is claimed is:

1. A UV adhesion-reducing adhesive for a polyolefin (PO) protective film for wafer dicing, prepared by raw materials comprising a component A and a component B, wherein
the component A comprises, in percentage by mass, 97-99.5% of an acrylate polymer, with a balance being a photoinitiator;
the component B comprises a curing agent; and
the acrylate polymer is an acrylate polymer containing an unsaturated branched chain.

2. The UV adhesion-reducing adhesive for the PO protective film for wafer dicing of claim 1, wherein materials for preparing the acrylate polymer comprise: an acrylic monomer, a functional cross-linking monomer, an initiator, a diisocyanate, a catalyst, and an organic solvent, wherein the functional cross-linking monomer is an acrylate monomer containing both an unsaturated double bond and a hydroxyl structure.

3. The UV adhesion-reducing adhesive for the PO protective film for wafer dicing of claim 2, wherein the acrylic monomer comprises at least one selected from the group consisting of methyl acrylate, ethyl acrylate, 2-ethylhexyl acrylate, butyl acrylate, hydroxyethyl acrylate, hydroxypropyl methacrylate, methacrylic acid, methyl methacrylate and butyl methacrylate.

4. The UV adhesion-reducing adhesive for the PO protective film for wafer dicing of claim 3, wherein the acrylic monomer comprises the 2-ethylhexyl acrylate, the butyl acrylate, the hydroxyethyl acrylate, the hydroxypropyl methacrylate and the methacrylic acid; and
a weight ratio of the 2-ethylhexyl acrylate, the butyl acrylate, the hydroxyethyl acrylate, the hydroxypropyl methacrylate, and the methacrylic acid is in a range of (10-15):(8-12):(1-4):(2-5):(1-3).

5. The UV adhesion-reducing adhesive for the PO protective film for wafer dicing of claim 2, wherein the functional cross-linking monomer is one selected from the group consisting of pentaerythritol triacrylate and hydroxyethyl acrylate.

6. The UV adhesion-reducing adhesive for the PO protective film for wafer dicing of claim 5, wherein the acrylate polymer is prepared by a process comprising:
(1) mixing the acrylic monomer with the initiator and the organic solvent, and subjecting a resulting mixture to a first reaction to obtain an acrylate oligomer;
(2) mixing the functional cross-linking monomer with the diisocyanate and the catalyst to obtain a polyurethane acrylate prepolymer containing an unsaturated double bond and an isocyanate group; and
(3) mixing products obtained in steps (1) and (2), and subjecting a resulting mixed system to a second reaction to generate the acrylate polymer containing the unsaturated branched chain.

7. The UV adhesion-reducing adhesive for the PO protective film for wafer dicing of claim 6, wherein under a condition that the functional cross-linking monomer is the pentaerythritol triacrylate, in step (3), the products obtained in steps (1) and (2) are mixed at a molar ratio of —OH to —NCO of 1:(0.15-0.25).

8. The UV adhesion-reducing adhesive for the PO protective film for wafer dicing of claim 6, wherein under a condition that the functional cross-linking monomer is the hydroxyethyl acrylate, in step (3), the products obtained in steps (1) and (2) are mixed at a molar ratio of —OH to —NCO of 1:(0.65-0.95).

9. The UV adhesion-reducing adhesive for the PO protective film for wafer dicing of claim 1, wherein the photoinitiator comprises 1-hydroxycyclohexyl phenyl ketone and 2,4,6-trimethylbenzoyldiphenyl phosphine oxide; and a weight ratio of the 1-hydroxycyclohexyl phenyl ketone to the 2,4,6-trimethylbenzoyldiphenyl phosphine oxide is in a range of 1:(1.1-1.5).

10. A method for preparing the UV adhesion-reducing adhesive for the PO protective film for wafer dicing of claim 1, comprising:
sequentially adding the acrylate polymer and the photoinitiator to a reaction kettle, and stirring until the photoinitiator is completely dissolved; discharging a resulting material to obtain the component A; and
in use, mixing the component A and the component B according to formula amounts to obtain the UV adhesion-reducing adhesive product,
wherein all preparation processes are conducted under yellow light conditions.

11. The method of claim 10, wherein materials for preparing the acrylate polymer comprise: an acrylic monomer, a functional cross-linking monomer, an initiator, a diisocyanate, a catalyst, and an organic solvent, wherein the functional cross-linking monomer is an acrylate monomer containing both an unsaturated double bond and a hydroxyl structure.

12. The method of claim 11, wherein the acrylic monomer comprises at least one selected from the group consisting of methyl acrylate, ethyl acrylate, 2-ethylhexyl acrylate, butyl acrylate, hydroxyethyl acrylate, hydroxypropyl methacrylate, methacrylic acid, methyl methacrylate and butyl methacrylate.

13. The method of claim 12, wherein the acrylic monomer comprises the 2-ethylhexyl acrylate, the butyl acrylate, the hydroxyethyl acrylate, the hydroxypropyl methacrylate and the methacrylic acid; and
a weight ratio of the 2-ethylhexyl acrylate, the butyl acrylate, the hydroxyethyl acrylate, the hydroxypropyl methacrylate, and the methacrylic acid is in a range of (10-15):(8-12):(1-4):(2-5):(1-3).

14. The method of claim 11, wherein the functional cross-linking monomer is one selected from the group consisting of pentaerythritol triacrylate and hydroxyethyl acrylate.

15. The method of claim 14, wherein the acrylate polymer is prepared by a process comprising:
(1) mixing the acrylic monomer with the initiator and the organic solvent, and subjecting a resulting mixture to a first reaction to obtain an acrylate oligomer;
(2) mixing the functional cross-linking monomer with the diisocyanate and the catalyst to obtain a polyurethane acrylate prepolymer containing an unsaturated double bond and an isocyanate group; and
(3) mixing products obtained in steps (1) and (2), and subjecting a resulting mixed system to a second reaction to generate the acrylate polymer containing the unsaturated branched chain.

16. The method of claim 15, wherein under a condition that the functional cross-linking monomer is the pentaerythritol triacrylate, in step (3), the products obtained in steps (1) and (2) are mixed at a molar ratio of —OH to —NCO of 1:(0.15-0.25).

17. The method of claim 15, wherein under a condition that the functional cross-linking monomer is the hydroxyethyl acrylate, in step (3), the products obtained in steps (1) and (2) are mixed at a molar ratio of —OH to —NCO of 1:(0.65-0.95).

18. The method of claim 10, wherein the photoinitiator comprises 1-hydroxycyclohexyl phenyl ketone and 2,4,6-trimethylbenzoyldiphenyl phosphine oxide; and a weight ratio of the 1-hydroxycyclohexyl phenyl ketone to the 2,4,6-trimethylbenzoyldiphenyl phosphine oxide is in a range of 1:(1.1-1.5).
